(19) United States
(12) Patent Application Publication
(10) Pub. No.: US 2023/0297626 A1
(43) Pub. Date: Sep. 21, 2023

(54) METHOD AND SYSTEM FOR FACILITATING GRAPH CLASSIFICATION

(71) Applicant: Armand E. Prieditis, MCKINLEYVILLE, CA (US)

(72) Inventor: Armand E. Prieditis, MCKINLEYVILLE, CA (US)

(21) Appl. No.: 17/700,394

(22) Filed: Mar. 21, 2022

(51) Int. Cl. G06F 16/906; G06F 16/901

(52) U.S. Cl. CPC G06F 16/906; G06F 16/9024

(57) ABSTRACT

During operation, embodiments of the subject matter can perform graph classification. One embodiment of the subject matter can facilitate graph classification by maintaining locality like a Hidden Markov Model (HMM), can handle confluences unlike an HMM, and can improve accuracy by including the class at every phase unlike an MPNN and in Deep Learning.

### BACKGROUND

### Field

The subject matter relates to graph classification.

### Related Art

A graph comprises a non-empty set of nodes, each connected to at least one neighbor node by an edge. Graph classification involves determining a class based on a graph.

Graph classification is important because it has several practical applications in fields such as bioinformatics, drug development, chemo-informatics, social network analysis, urban computing, and cyber-security. In all of these applications, the underlying representation of the data can be naturally represented as a graph. For example, a molecule can be represented as a graph with atoms as nodes and bonds as edges between pairs of atoms. The classification task might be to predict whether or not a particular molecule has a property of interest such as toxicity, antibiotic property, and anti-cancer activity.

Accurate molecule property prediction is crucial to reduce the time and cost of developing new drugs. This is because drug development typically involves a large number of biological experiments and tests called “assays,” which measure the biological effects of a candidate molecule. Testing a few thousand molecules for as few as twelve toxic effects can cost millions of dollars. Typical drug development timelines span 10-20 years and cost up to $2.6 billion. A lengthy time-to-market and high costs can also result in higher prices for approved drugs to offset costs for earlier failures.

Drug discovery can also involve predicting interactions between proteins and other biomolecules purely based on structure. This is currently an unsolved problem in biology, one that graph classification based on machine learning and historical data could address.

At a macro scale, interactomes can be modeled as graphs that capture specific types of interactions between biomolecular species such as protein—protein interaction. At an even higher scale, graphs can represent relationships between drugs, side effects, diagnoses, treatments, and lab tests.

Drug repurposing, which is using an existing drug for a purpose other than the originally intended indication, is another area of drug discovery for which ranking of candidate molecules can be important. Since only 12% of drugs in development receive FDA approval, repurposed drugs can offer a faster path to market, since it is likely that a substantial portion of required toxicity testing and safety assessment will have already been conducted and reviewed by FDA. It is estimated that about 75% of all FDA approved drugs could be repurposed. Graph classification with candidate molecules could identify such drugs.

Classical chemical and genetic screens are heavily used in drug screening, but suffer from extremely low accuracy (1%-3% hit rates). Graph classification of molecules shows promise to increase accuracy, but accurate graph classification is difficult for two reasons. First, graphs are permutation invariant, which means that order of the neighbors can be permuted and the interpretation of a graph should be the same. Second, a graph can vary in size and the nodes of a graph can vary in the number of neighbors. In contrast, a standard machine learning classification method expects a fixed input ordering and a fixed input size.

Several methods have been developed to summarize a graph in a permutation-invariant way so that the results can then be fed into a machine learning method. One of the main methods involves Message Passing Neural Networks (MPNNs). MPNNs operate in two phases: propagation and readout. Propagation updates a “state” at each node based on neighbor states and edge data. After multiple such updates, readout aggregates all node states to produce a single output, which can then be fed into a standard machine learning method (e.g., a neural network) together with a target of interest.

The state update function is typically defined as follows:

$${h}_{v}^{t + 1} = U ( {h}_{v}^{t} , {A}_{w ∈ N ( v )} \{ M ( {h}_{w}^{t} , {e}_{v , w} , {h}_{v}^{t} ) \} ) ,$$

where Hᵥ^{t} and hᵥ^{t+1} correspond to the state at node v for times t and t+1, respectively, N(v) returns the set of neighbors of node v, e_{v,w} corresponds to data at an undirected edge between nodes v and w, A is an aggregation function (e.g., sum, mean, min, or max) over nodes, M is a function that operates on data at the node v and w and the data at the edge between the two nodes, U is function that operates on the state at node v and the aggregation of neighbor node states. Initially, hᵥ⁰=I(nᵥ), where I operates on the initial data at node v, which is denoted by nᵥ. For example, the initial data at a node representing an atom might include atom type, valence, mass, and number of hydrogen bonds.

After a fixed number of state updates, the entire graph can then be summarized with a readout (aggregation) function R, where

$$\hat{y} = {R}_{v ∈ G} \{ {h}_{v}^{t} \} .$$

Finally, ŷ can then be fed into a neural network, which then produces a classification.

MPNNs suffer from several shortcomings. First, in limit of updates, a node's state converges to the average of its neighbors, which destroys locality for classification. Here, locality means that some parts of the graph can be more important than others. Second, the target is not considered until after it is returned from a neural net, which takes as input ŷ. This can again result in low accuracy because the state propagation doesn't take into account the target.

In contrast, Hidden Markov Models (HMMs) maintain locality by setting a node's label to the most likely value based on the states of its neighbors and the data at the node. Moreover, setting the label only happens once, through Dynamic Programming, and is guaranteed to be an optimal setting over the entire graph. This is because particular type of graph on which HMMs operate is a directed graph with at most one neighbor.

HMMs have been successfully applied to natural language processing, speech recognition, machine maintenance, acoustics, biosciences, handwriting analysis, text recognition, gene sequencing, intrusion detection, gesture recognition, and image processing.

Because HMMs are limited to directed graphs that have at most one neighbor (i.e., sequences) they cannot be applied to graphs with confluences. For example, in an undirected graph such as a molecule, each node is confluent with itself. This precludes the application of HMMs to graphs such as those that represent molecules.

Hence, what is needed is a method and a system for graph classification that that maintains locality like an HMM but yet can be applied to graphs with confluences and includes the target at every phase of classification.

### SUMMARY

One embodiment of the subject matter can facilitate graph classification by maintaining locality like an HMM, can handle confluences unlike an HMM, and can improve accuracy by including the class at every phase unlike an MPNN and in Deep Learning. In addition, these embodiments are permutation invariant because they assume conditional independence of neighbors.

The details of one or more embodiments of the subject matter are set forth in the accompanying drawings and the description below. Other features, aspects, and advantages of the subject matter will become apparent from the description, the drawings, and the claims.

### BRIEF DESCRIPTION OF THE FIGS.

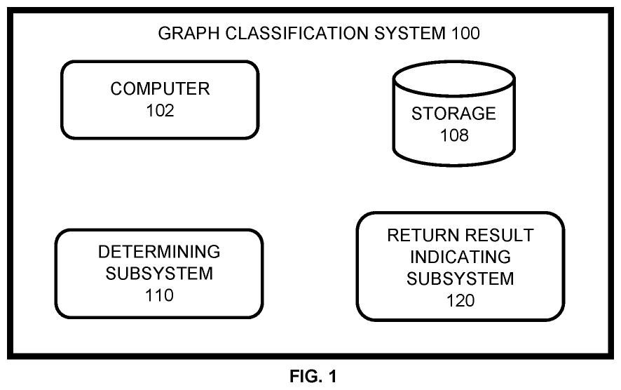

FIG. 1 presents an example system for facilitating graph classification.

In the figures, like reference numerals refer to the same figure elements.

### DETAILED DESCRIPTION

To better understand this embodiment, consider the following update function, which can be applied to every node v in a non-empty set of nodes V in a graph for which a classification is desired, over every class c and time increment t:

$${l}_{v , c}^{t + 1} = {arg max}_{{l}^{′} ∈ L} \{ p ( {n}_{v} , {l}^{′} \vert {∧}_{w ∈ N ( v )} ( {n}_{w} , {e}_{v , w} , {l}_{w}^{t} ) , c ) \} ,$$

N(v) corresponds to a non-empty multiset of the neighbors of node v (i.e., those connected by an edge in the graph, which can be a multi-graph), L comprises a non-empty set of labels, xᵥ corresponds to data at node v, e_{v,w} corresponds to data at the edge between node v and node w, l_{w,c}^{t}∈L corresponds to a label at node w for time t for class c, l_{v,c}^{t+1}∈L corresponds to a label at node v for time t+1 for class c, ∧_{w∈N(v)}(n_{w}, e_{v,w}, l_{w}^{t}) is a conjunction of the neighbors comprising n_{w}, e_{v,w}, l_{w}^{t} for each neighbor w, c is a class corresponding to a target of prediction, and p is a conditional probability function.

The initial value l_{v,c}⁰ can be set to f(v, c) for each class c and each node v, where f(v, c) returns a label for a node v and class c. For example, f can randomly sample from the distribution of labels in L based on the node value nᵥ and class c.

Typically, the set of labels L={1 . . . k}, where k is a positive integer. Labels are like mixture components in a mixture model: they are anonymous in that a label is an identifier for a component. More generally, the set of labels can be any finite set of k elements such as {a,b,c,d}. During operation, embodiments of the subject matter treat the set {a,b,c,d} the same as the set {1,2,3,4}. Though the labels have different names, the number of labels is the same and hence these two different label sets are treated equivalently. For convenience of implementation, a preferred embodiment of the subject matter uses labels L={1 . . . k}, which is equivalent to any k element set of labels during operation of embodiments of the subject matter.

This update function differs from those of MPNNs in several ways. First, the update is based on a most likely label rather than an aggregation of neighbor values. Unlike in an MPNN, which doesn't use labels, this update maintains locality. Second, the argmax function is non-linear and can support classification tasks that are more complex. In contrast, the most commonly used MPNN aggregation functions are linear. Third, the updates are conditioned on the class c. MPNNs do not condition their updates on the class c. Fourth, the update in embodiments of the subject matter is based both on the original data for xᵥ and x_{w} as well as the label. In an MPNN, the original data at a node is destroyed once the propagation begins.

Fifth, classification in embodiments of the subject matter does not require an aggregation function that summarizes values over all nodes and then inputs those values into a neural net. Instead, a most likely class is defined by

$${arg max}_{c ∈ C} \{ p ( c ) {\prod }_{v ∈ V} p ( {n}_{v} , {l}_{v , c}^{t} \vert {∧}_{w ∈ N ( v )} ( {n}_{w} , {e}_{v , w} , {l}_{w , c}^{t} ) , c ) \} ,$$

where C is a set of non-empty classes, V is a non-empty set of nodes in a graph, p(c) is the probability of the class c, and t is a time index associated with when l_{v,c}^{t} has converged. For example, V might correspond to the nodes of a candidate molecule and C might correspond to {antibiotic=true, antibiotic=false}. Embodiments of the subject matter do not require a separate feed into a classifier after readout: all updates include the target of classification and there is no readout.

Convergence can be defined in multiple ways. For example, l_{v,c}^{t} can be updated a fixed number of times. The problem with this approach is that l_{v,c}^{t} may have long converged before that fixed number of times is reached. Or, l_{v,c}^{t} may be far away from convergence after that fixed number of times is reached. Convergence can also be defined when a function of the difference between successive likelihoods is below a given threshold for a class c, where likelihood over nodes V in a graph for a particular class c can be defined as p(c)Π_{v∈V}p(nᵥ, l_{v,c}^{t}|∧_{w∈N}(n_{w}, e_{v,w}, l_{w,c}^{t)},c). Convergence can also be defined as reaching a local maximum in likelihood.

A problem with the update function

$${l}_{v , c}^{t + 1} = {arg max}_{{l}^{′} ∈ L} \{ p ( {n}_{v} , {l}^{′} \vert {∧}_{w ∈ N ( v )} ( {n}_{w} , {e}_{v , w} , {l}_{w}^{t} ) , c ) \}$$

is that it is not permutation-invariant: the order in which the neighbors appear is fixed and different results will occur with different neighbor orderings. Embodiments of the subject matter can be transformed into a permutation-invariant version of this update function based on an assumption of conditional independence, which will be described in the following derivation.

By Bayes Theorem,

$${arg max}_{{l}^{′} ∈ L} \{ p ( {n}_{v} , {l}^{′} \vert {∧}_{w ∈ N ( v )} ( {n}_{w} , {e}_{v , w} , {l}_{w , c}^{t} ) , c ) \} = {arg max}_{{l}^{′} ∈ L} \{ \frac{p ( {∧}_{w ∈ N ( v )} ( {n}_{w} , {e}_{v , w} , {l}_{w , c}^{t} ) \vert {n}_{v} , {l}^{′} , c ) p ( {n}_{∧} , {l}^{′} \vert c )}{p ( {∧}_{w ∈ N ( v )} ( {n}_{w} , {e}_{v , w} , {l}_{w , c}^{t} ) , c )} \} .$$

Since the denominator is not a function of l′, which is the subject of maximization in argmax, the denominator can be eliminated as it is a constant over all values of l′. This results in

$${arg max}_{{l}^{′} ∈ L} \{ p ( {∧}_{w ∈ N ( v )} ( {n}_{w} , {e}_{v , w} , {l}_{w , c}^{t} ) \vert {n}_{v} , {l}^{′} , c ) p ( {n}_{v} , {l}^{′} \vert c ) \} .$$

Assuming conditional independence over each of the neighbors, this results in

$${arg max}_{{l}^{′} ∈ L} \{ p ( {n}_{v} , {l}^{′} \vert c ) {\prod }_{w ∈ N ( v )} p ( {n}_{w} , {e}_{v , w} , {l}_{w , c}^{t} \vert {n}_{v} , {l}^{′} , c ) \} ,$$

which is permutation invariant because the order in which the neighbors appear is irrelevant.

Similarly, the likelihood function for each class under the independence assumption becomes:

p(c)Π_{v∈V}p(nᵥ, l_{v,c}^{t}|c)Π_{w∈N(v)}p(n_{w}, e_{v,w}, l_{w,c}^{t}|nᵥ, l_{v,c}^{t}, c)

Note that embodiments of the subject matter can also be used to classify multigraphs, which can contain more than one edge between any two nodes. For example, a molecule can be represented as a multigraph where the nodes are atoms and the edge are bonds. An atom in this multigraph can be bonded more than once to the same other atom. For example, a carbon atom can be bonded several times to the same atom (e.g., as in a double or triple bond).

Another embodiment of the subject matter is more representationally efficient but equivalent to a multigraph by including a strength factor between two nodes, s_{v,w}, which can correspond to the number of duplicated edges between two nodes. In this embodiment, N(v) is defined as a set (not a multiset) of neighbors of v. This embodiment uses the following function for updates of l_{v,c}^{t+1}:

$${arg max}_{{l}^{′} ∈ L} \{ p ( {n}_{v} , {l}^{′} \vert c ) {\prod }_{w ∈ N ( v )} {p ( {n}_{w} , {e}_{v , w} , {l}_{w , c}^{t} \vert {n}_{v} , {l}^{′} , c )}^{{s}_{v , w}} \} .$$

This embodiment can facilitate capturing the strength of the relationship between two nodes without requiring explicit repetition in a multiset version of N(v). Note that strength s_{v,w} is not the same as data associated with the edge e_{v,w} because in a multigraph two nodes v and w can have k edges with the same data e_{v,w}. In this example, s_{v,w}=k whereas e_{v,w} can be any data. The strength s_{v,w} boosts the weight of the edge, whereas e_{v,w} is merely data at the edge, which is in classification and learning is treated neutrally in terms of boosting the weight of the edge.

More generally, s_{v,w} can capture the strength of the connection rather than just the number of edges between v and w: it is not required to be a positive integer. For example, a negative strength s_{v,w} can correspond to a inhibitory relationship between v and w and a positive strength s_{v,w} can correspond to an excitatory relationship between v and w.

Analogously, in this embodiment of the subject matter the likelihood function becomes: p(c)Π_{v∈V}p(nᵥ, l_{v,c}^{t}|c)Π_{w∈N(v)}p(n_{w}, e_{v,w}, l_{w,c}^{t}|nᵥ, l_{v,c}^{t}, c)^{s}^{_{v,w}}, where N(v) is a non-empty set (not a multiset) of neighbors of node v. Henceforth, N(v) will refer to non-empty set of neighbors of the node v rather than a multiset.

A product of probabilities can result in extremely low numbers, which can cause hardware underflow. A preferred embodiment of the subject matter uses an equivalent version of the update function, but with summations instead of products:

$${l}_{v , c}^{t + 1} = {arg max}_{{l}^{′} ∈ L} \{ log p ( {n}_{v} , {l}^{′} \vert c ) + {\sum }_{w ∈ N ( v )} {s}_{v , w} log p ( {n}_{w} , {e}_{v , w} , {l}_{w , c}^{t} \vert {n}_{v} , {l}^{′} , c ) \} .$$

The log function can be any base. A preferred base in natural logarithm, which, as will be shown is useful in simplification of Gaussians. Analogously, the summation form of the likelihood function is log p(c)+Σ_{v∈V}(log p(nᵥ, l_{v,c}^{t}|c)+Σ_{w∈N(v)}s_{v,w}log p(n_{w}, e_{v,w}, l_{w,c}^{t},c)).

The function log p(nᵥ, l_{v,c}^{t}|c) can be represented several different ways, including based on any current or to-be-invented machine learning method.

In a preferred embodiment of the subject matter, log p(nᵥ, l_{v,c}^{t}|c)=log N(xₐ; \hat{μ}ₐ, \hat{Σ}), where x is column vector conformably partitioned as

$$[ \begin{matrix}{x}_{a} \\ {x}_{b}\end{matrix} ] ,$$

where

$${x}_{a} = [ \begin{matrix}{n}_{v} \\ o ( {l}_{v , c}^{t} )\end{matrix} ]$$

and x_{b}=[o(c)], \hat{μ}ₐ=μₐ+Σ_{a,b}Σ_{b}⁻¹(x_{b}−μ_{b}), \hat{Σ}ₐ=Σ_{a,b}Σ_{b}⁻¹Σ_{b,a}, Σ⁻¹ is the inversion operator, and o(y) corresponds to a one-hot representation of y. The mean column vector μ is conformably partitioned as

$$[ \begin{matrix}{μ}_{a} \\ {μ}_{b}\end{matrix} ]$$

using the same partitioning as for x. Similarly, the covariance matrix Σ is conformably partitioned as

$$[ \begin{matrix}{\sum }_{a} & {\sum }_{a , b} \\ {\sum }_{b , a} & {\sum }_{b}\end{matrix} ] .$$

### Here, log

$$N ( x ; μ , \sum ) = - \frac{1}{2} [ log \vert \sum \vert + {( x - μ )}^{T} {\sum }^{- 1} ( x - μ ) ] ,$$

μ and Σ correspond to a mean and a covariance matrix of a multivariate Gaussian distribution, log|Σ| is a log determinant of Σ, and T is the transposition operator. Note that Σ_{b,a} is the transposition of Σ_{a,b} and vice versa.

A one-hot representation is frequently used in machine learning to handle categorical data. In this representation a k-category variable is converted to a k-length vector, where a 1 in location i of the k-length vector corresponds to the i^{th} categorical variable; the rest of the vector values are 0. For example, if the categories are A, B, and C, then a one-hot representation corresponds to a length three vector where A can be represented as

$$[ \begin{matrix}1 \\ 0 \\ 0\end{matrix} ] ,$$

### B as

$$[ \begin{matrix}0 \\ 1 \\ 0\end{matrix} ] ,$$

### and C as

$$[ \begin{matrix}0 \\ 0 \\ 1\end{matrix} ] .$$

Other permutations of the vector can be used to equivalently represent the same three categorical variables. One-hot representations are useful in classification methods based on numeric rather than categorical variables.

Categorical data can be nominal or ordinal. Ordinal data has a ranked order for its values and can therefore be converted to numerical data through ordinal encoding. Nominal data has no quantitative relationship between values, so naively using an ordinal encoding can potentially create a false ordinal relationship in the data. So, one-hot representation is often applied to nominal data to improve performance and avoid creation of false relationships.

Similarly, log p(n_{w}, e_{v,w}, l_{w,c}^{t}|nᵥ, l_{v,c}^{t}, c) can be represented several different ways, including with any current or to-be-invented machine learning method. In a preferred embodiment of the subject matter, log p(n_{w}, e_{v,w}, l_{w,c}^{t}|nᵥ, l_{v,c}^{t}, c)=log N (\dot{x}ₐ; \dot{\hat{μ}}ₐ, \dot{\hat{Σ}}ₐ), where \dot{x} is column vector conformably partitioned as

$$[ \begin{matrix}{\dot{x}}_{a} \\ {\dot{x}}_{b}\end{matrix} ] ,$$

where

$${\dot{x}}_{a} = [ \begin{matrix}{n}_{w} \\ {e}_{v , w} \\ o ( {l}_{w , c}^{t} )\end{matrix} ]$$

and

$${\dot{x}}_{b} = [ \begin{matrix}{n}_{v} \\ o ( {l}_{v , c}^{t} ) \\ o ( c )\end{matrix} ] ,$$

\dot{\hat{μ}}ₐ=\dot{μ}ₐ+\dot{Σ}_{a,b}\dot{Σ}_{b}⁻¹(\dot{x}_{b}−\dot{μ}_{b}), \dot{\hat{Σ}}ₐ=\dot{Σ}ₐ−\dot{Σ}_{a,b}\dot{Σ}_{b}⁻¹\dot{Σ}_{b,a}, and o(y) corresponds to a one-hot representation of y. The mean column vector \dot{μ} is conformably partitioned as

$$[ \begin{matrix}{\dot{μ}}_{a} \\ {\dot{μ}}_{b}\end{matrix} ]$$

using the same partitioning as for \dot{x}. Similarly, the covariance matrix \dot{Σ} is conformably partitioned as

$$[ \begin{matrix}{\dot{\sum }}_{a} & {\dot{\sum }}_{a , b} \\ {\dot{\sum }}_{b , a} & {\dot{\sum }}_{b}\end{matrix} ] .$$

During operation, embodiments of the subject matter can learn μ, Σ, \dot{μ}, \dot{Σ}, p(c) based on training data: Training data can comprise a non-empty set of graphs G , each of which is denoted by an identifier g, which can be used to identify the nodes, node data, edge data, neighbors of nodes, and the class associated with each graph. For example, p(c) can be based on the total number of c class graphs in the training data divided by the total number of graphs in the training data.

Embodiments of the subject matter can initialize l_{v,g}⁰ to a randomly chosen label in L for each ∀v∈V(g) for each ∀g∈G, where V(g) corresponds to a non-empty set of nodes for graph g and l_{v,g}⁰ corresponds to the initial label for node v in graph g. As will be described, many of the functions and subscripts used in classification are similar to those used in learning, except that an additional subscript g is required to identify the appropriate graph in the training data. Note that for learning μ, Σ, \dot{μ}, \dot{Σ} and p(c), l_{v,g}^{t} is indexed both on the node v and the graph g, since each node in each graph needs its own separate label at time t.

Subsequently, μ, Σ, \dot{μ}, and \dot{Σ} can be determined based on this initialization and the data over each node in each graph and the neighbor nodes of each node in each graph. For example, μ and Σ can be determined based on

$$[ \begin{matrix}{n}_{v , g} \\ o ( {l}_{v , g}^{t} ) \\ o ( {c}_{g} )\end{matrix} ]$$

over all v∈V(g) over all g∈G. Similarly, \dot{μ}, and \dot{Σ} can be determined based on

$$[ \begin{matrix}{n}_{w} \\ {e}_{v , w} \\ o ( {l}_{w , g}^{t} ) \\ {n}_{v} \\ o ( {l}_{v , g}^{t} ) \\ o ( {c}_{g} )\end{matrix} ]$$

over all w∈N(v,g) over all v∈V(g) over all g∈G.

Once μ, Σ, \dot{μ}, and \dot{Σ} are determined, l_{v,g}^{t+1} can be determined for all v∈V(g) for all g∈G based on

$${arg max}_{{l}^{′} ∈ L} \{ log p ( {n}_{v , g} , {l}^{′} \vert {c}_{g} ) +$$

$${\sum }_{w ∈ N ( v , g )} {s}_{v , w , g} log p ( {n}_{w , g} , {e}_{v , w , g} , {l}_{w , g}^{t} \vert {n}_{v , g} , {l}^{′} , {c}_{g} ) \} ,$$

where n_{v,g} corresponds to data at node v in graph g, c_{g} corresponds to the class associated with graph g, N(v,g) returns a non-empty set of neighbors of node v in graph g, s_{v,w,g} corresponds to the strength of the edge between node v and node w in graph g, n_{w,g} corresponds to data at node w in graph g, e_{v,w,g} corresponds to data at the edge between node v and node w in graph g, and l_{v,g}^{t+1} and l_{w,g}^{t} correspond to the labels at time t+1 for node v in graph g and time t for node w in graph g, respectively.

Once l_{v,g}^{t+1} is determined, the following cycle can repeat until convergence: update μ, Σ, \dot{μ}, and \dot{Σ} based on the current value l_{v,g}^{t+1} of as described above and then determine l_{v,g}^{t+1} for all nodes v∈V(g) for all graphs g∈G. Of course, with each update, time t is advanced to the next increment.

An appropriate number of labels L (as in {1 . . . k}) can be determined in multiple different ways. For example, a validation set of graphs can be reserved and used to evaluate the likelihood of the graphs using the aforementioned likelihood function. The number of labels can be explored from 1 . . . k until a maximum in the likelihood is found (peak method) or until the likelihood does not significantly increase (the elbow method).

FIG. 1 shows an example graph classification system 100 in accordance with an embodiment of the subject matter. Graph classification system 100 is an example of a system implemented as a computer program on one or more computers in one or more locations (shown collectively as computer 102), with one or more storage devices (shown collectively as storage 108), in which the systems, components, and techniques described below can be implemented.

During operation, graph classification system 100 determines l_{v,c}^{t+1} based on argmax over l′∈L of a first function based on xᵥ, l′ and c and a second function based on n_{w}l_{w,c}^{t}, nᵥ, l′, and c with determining subsystem 110. Subsequently, graph classification system 100 returns a result indicating l_{v,c}^{t+1} with return result indicating subsystem 120.

The preceding description is presented to enable any person skilled in the art to make and use the subject matter, and is provided in the context of a particular application and its requirements. Various modifications to the disclosed embodiments will be readily apparent to those skilled in the art, and the general principles defined herein may be applied to other embodiments and applications without departing from the spirit and scope of the subject matter. Thus, the subject matter is not limited to the embodiments shown, but is to be accorded the widest scope consistent with the principles and features disclosed herein.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory program carrier for execution by, or to control the operation of data processing system.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

Alternatively, or in addition, the program instructions can be encoded on an artificially generated propagated signal, e.g., a machine-generated electrical, optical, or electromagnetic signal, that is generated to encode information for transmission to a suitable receiver system for execution by a data processing system. The computer storage medium can be a machine-readable storage device, a machine-readable storage substrate, a random or serial access memory device, or a combination of one or more of them.

Computers suitable for the execution of a computer program include, by way of example, can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data.

A computer can also be distributed across multiple sites and interconnected by a communication network, executing one or more computer programs to perform functions by operating on input data and generating output.

A computer can also be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Generally, a computer will also include, or be operatively coupled to receive data from or transfer data to, or both, one or more mass storage devices for storing data, e.g., magnetic, magneto optical disks, or optical disks. However, a computer need not have such devices.

The term “data processing system’ encompasses all apparatus, devices, and machines for processing data, including by way of example a programmable processor, a computer, or multiple processors or computers.

For a system of one or more computers to be configured to perform particular operations or actions means that the system has installed on it in software, firmware, hardware, or a combination of them that in operation cause the system to perform the operations or actions. For one or more computer programs to be configured to perform particular operations or actions means that the one or more programs include instructions that, when executed by data processing system, cause the system to perform the operations or actions.

The processor and the memory can be supplemented by, or incorporated in, special purpose logic circuitry. More generally, the processes and logic flows can also be performed by and be implemented as special purpose logic circuitry, e.g., an FPGA (field programmable gate array) or an ASIC (application specific integrated circuit), a dedicated or shared processor that executes a particular software module or a piece of code at a particular time, and/or other programmable-logic devices now known or later developed. When the hardware modules or system are activated, they perform the methods and processes included within them.

The system can also include, in addition to hardware, code that creates an execution environment for the computer program in question, e.g., code that constitutes processor firmware, a protocol stack, a database management system, an operating system, or a combination of one or more of them.

The computer-readable storage medium includes, but is not limited to, volatile memory, non-volatile memory, magnetic and optical storage devices such as disk drives, magnetic tape, CDs (compact discs), DVDs (digital versatile discs or digital video discs), computer instruction signals embodied in a transmission medium (with or without a carrier wave upon which the signals are modulated), and other media capable of storing computer-readable media now known or later developed. For example, the transmission medium may include a communications network, such as a LAN, a WAN, or the Internet.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

The methods and processes described in the detailed description section can be embodied as code and/or data, which can be stored in a computer-readable storage medium as described above. When a computer system reads and executes the code and/or data stored on the computer-readable storage medium 120, the computer system performs the methods and processes embodied as data structures and code and stored within the computer-readable storage medium.

The components of the system can be interconnected by any form or medium of digital data communication, e.g., a communication network. Examples of communication networks include a local area network (“LAN”) and a wide area network (“WAN”), e.g., the Internet.

While this specification contains many specific implementation details, these should not be construed as limitations on the scope of any subject matter or of what may be claimed, but rather as descriptions of features that may be specific to particular embodiments of particular subject matters. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system modules and components in the embodiments described above should not be understood as requiring such separation in all embodiments, and it should be understood that the described program components and systems can generally be integrated together in a single software product or packaged into multiple software products.

The foregoing descriptions of embodiments of the subject matter have been presented only for purposes of illustration and description. They are not intended to be exhaustive or to limit the subject matter to the forms disclosed.

Accordingly, many modifications and variations will be apparent to practitioners skilled in the art. Additionally, the above disclosure is not intended to limit the subject matter. The scope of the subject matter is defined by the appended claims.

What is claimed is:

1. A computer-implemented method for facilitating graph classification comprising:
determining l_{v,c}^{t+1} based on argmax over l′∈L of a first function based on nᵥ, l′ and c and a second function based on n_{w}, l_{w,c}^{t}, nᵥ, l′, and c,
wherein L corresponds to a non-empty set of labels,
wherein v corresponds to a node in a graph,
wherein t corresponds to a discrete time point,
wherein w corresponds to a neighbor of node v,
wherein nᵥ corresponds to data at node v,
wherein c is a class corresponding to a prediction target,
wherein n_{w} corresponds to data at node w,
wherein l_{w,c}^{t+1}∈L corresponds to a label at node w and class c for time t, and
wherein l_{v,c}^{t+1}∈L corresponds to a label at node v and class c for time t+1; and
returning a resulting indicating l_{v,c}^{t+1}.

2. The method of claim 1,
wherein the second function is additionally based on e_{v,w} and
wherein e_{v,w} corresponds to data at an edge between node v and node w.

3. The method of claim 1,
wherein the second function is additionally based on s_{v,w}, and
wherein s_{v,w} corresponds to a strength of an edge between node v and node w. 4. The method of claim 1,
wherein the first function is based on a multivariate Gaussian. 5. The method of claim 1,
wherein the second function is based on a multivariate Gaussian.

6. The method of claim 1,
wherein the first and second functions are machine-learned from training data.

7. One or more non-transitory computer-readable storage media storing instructions that when executed by one or more computers cause the one or more computers to perform operations for facilitating graph classification, comprising:
determining l_{v,c}^{t+1} based on argmax over l′∈L of a first function based on nᵥ, l′ and c and a second function based on n_{w}, l_{w,c}^{t}, n_{c}, l′, and c,
wherein L corresponds to a non-empty set of labels,
wherein v corresponds to a node in a graph,
wherein t corresponds to a discrete time point,
wherein w corresponds to a neighbor of node v,
wherein nᵥ corresponds to data at node v,
wherein c is a class corresponding to a prediction target,
wherein n_{w} corresponds to data at node w,
wherein l_{w,c}^{t}∈L corresponds to a label at node w and class c for time t, and
wherein l_{v,c}^{t+1}∈L corresponds to a label at node v and class c for time t+1; and
returning a resulting indicating lᵥ^{t+1}.

8. The one or more non-transitory computer-readable storage media of claim 7,
wherein the second function is additionally based on e_{v,w}, and
wherein e_{v,w} corresponds to data at an edge between node v and node w.

9. The one or more non-transitory computer-readable storage media of claim 7,
wherein the second function is additionally based on s_{v,w}, and
wherein s_{v,w} corresponds to a strength of an edge between node v and node w.

10. The one or more non-transitory computer-readable storage media of claim 7,
wherein the first function is based on a multivariate Gaussian.

11. The one or more non-transitory computer-readable storage media of claim 7,
wherein the second function is based on a multivariate Gaussian.

12. The one or more non-transitory computer-readable storage media of claim 7,
wherein the first and second functions are machine-learned from training data.

13. A system comprising one or more computers and one or more storage devices storing instructions that when executed by the one or more computers cause the one or more computers to perform operations for facilitating compression, comprising:
determining l_{v,c}^{t+1} based on argmax over l′∈L of a first function based on nᵥ, l′ and c and a second function based on n_{w}, l_{w,c}^{t}, xᵥ, l′, and c,
wherein L corresponds to a non-empty set of labels,
wherein v corresponds to a node in a graph,
wherein t corresponds to a discrete time point,
wherein w corresponds to a neighbor of node v,
wherein nᵥ corresponds to data at node v,
wherein c is a class corresponding to a prediction target,
wherein n_{w} corresponds to data at node w,
wherein l_{w,c}^{t}∈L corresponds to a label at node w and class c for time t, and
wherein l_{v,c}^{t+1}∈L corresponds to a label at node v and class c for time t+1; and
returning a resulting indicating lᵥ^{t+1}.

14. The system of claim 13, comprising:
wherein the second function is additionally based on e_{v,w}, and
wherein e_{v,w} corresponds to data at an edge between node v and node w.

15. The system of claim 13, comprising:
wherein the second function is additionally based on s_{v,w}, and
wherein s_{v,w} corresponds to a strength of an edge between node v and node w.

16. The system of claim 13,
wherein the first function is based on a multivariate Gaussian.

17. The system of claim 13,
wherein the second function is based on a multivariate Gaussian.

18. The system of claim 13,
wherein the first and second functions are machine-learned from training data.
